(19) United States
(12) Patent Application Publication
(10) Pub. No.: US 2026/0016380 A1
(43) Pub. Date: Jan. 15, 2026

(54) METHOD FOR PREPARING DYEING SAMPLE

(71) Applicant: GENERAL BIOLOGICALS CORPORATION, Baoshan Township (TW)

(72) Inventors: TZU RONG LIN, Baoshan Township (TW); LEO LIU, Baoshan Township (TW); FRANK LIN, Baoshan Township (TW); TSONG CHIN LIN, Baoshan Township (TW)

(21) Appl. No.: 19/097,879

(22) Filed: Apr. 2, 2025

Related U.S. Application Data
(60) Provisional application No. 63/668,861, filed on Jul. 9, 2024.

(30) Foreign Application Priority Data
Nov. 29, 2024 (TW) 113146186

(51) Int. Cl. G01N 1/30; G01N 1/36

(52) U.S. Cl. CPC G01N 1/30; G01N 1/36; G01N 2001/302; G01N 2001/305; G01N 2001/362

(57) ABSTRACT

A method for preparing dyeing sample. The method for preparing dyeing sample includes (a) passing a biological sample containing a object to be stained through an non-epoxy-based microfilm to collect the object to be stained on the non-epoxy-based microfilm; (b) immobilizing the object to be stained on the non-epoxy-based microfilm with a fixing agent at a fixation time; and (c) staining the object to be stained on the non-epoxy-based microfilm by using at least one filtered dye.

### BACKGROUND OF THE INVENTION

### 1. Field of the Invention

The present disclosure relates to sample preparation technology, and more particularly to a method for preparing a dyeing sample.

### 2. Description of the Prior Art

Circulating tumor cells (CTCs) are tumor cells that have entered the blood circulation from the site of tumor growth. These circulating tumor cells may invade other organs through the bloodstream, leading to the spread of tumor cells to other organs in the body, resulting in metastatic cancer.

Currently, there are many methods for detecting circulating tumor cells, which help determine the risk of cancer recurrence or tumor metastasis. The commonly used detection method involves first collecting circulating tumor cells from the blood, then using immunofluorescent staining assays to label and identify these circulating tumor cells.

Although immunofluorescent staining analysis has high specificity for specific biomarkers on circulating tumor cells, it has disadvantages of high cost and difficulty in sample preservation. Specifically, since immunofluorescent staining analysis requires fluorescence microscopes and fluorescent antibodies, the costs must include the purchase of fluorescence microscopes and fluorescent antibodies, both of which are very expensive. The cost of a fluorescence microscope alone is approximately 1 million New Taiwan dollars, so most laboratories generally do not purchase fluorescence microscopes independently. Additionally, fluorescent antibodies must be refrigerated before use to prevent fluorescence degradation, which incurs additional costs for storing the fluorescent antibodies. Furthermore, since the fluorescence in stained samples obtained after completing the immunofluorescent staining analysis is prone to degradation, there is also the issue of difficulty in effectively preserving these fluorescently stained samples.

In comparison, chemical staining techniques can avoid the aforementioned problems. Specifically, chemical staining techniques use optical microscopes and chemical dyes, where the price of an optical microscope (approximately 100,000 to 300,000 New Taiwan dollars) is much lower than that of a fluorescence microscope, so most laboratories have purchased their own optical microscopes. Additionally, the cost of purchasing chemical dyes is lower than that of purchasing fluorescent antibodies, and chemical dyes can generally be stored at room temperature and are less prone to degradation. Furthermore, chemically stained samples prepared through chemical staining techniques are relatively resistant to degradation, thus chemical stained samples have the advantage of long-term preservation.

The inventors of this disclosure discovered that when using non-epoxy-based microfilms to collect circulating tumor cells, conventional chemical staining techniques make it difficult to fix the circulating tumor cells on the non-epoxy-based microfilms and to successfully stain the circulating tumor cells on these on the non-epoxy-based microfilms. This makes it difficult to clearly distinguish between cytoplasmic and nuclear staining under an optical microscope, which remains an unresolved issue.

### SUMMARY OF THE INVENTION

The present disclosure provides a method for preparing a dyeing sample, including (a) passing a biological sample containing an object to be stained through an non-epoxy-based microfilm to collect the object to be stained on the non-epoxy-based microfilm; (b) immobilizing the object to be stained on the non-epoxy-based microfilm with a fixing agent for a fixed duration, wherein the fixation time is greater than or equal to 8 hours; and (c) staining the object to be stained on the non-epoxy-based microfilm by using at least one filtered dye.

In some embodiments of the present disclosure, the fixation time is 8 hours to 32 hours.

In some embodiments of the present disclosure, the at least one filtered dye is obtained by filtering at least one dye through a filter membrane.

In some embodiments of the present disclosure, a pore size of the filter membrane is less than or equal to 0.22 μm.

In some embodiments of the present disclosure, the fixing agent includes methanol, ethanol, denatured ethanol, propanol, isopropanol, diethyl ether, formaldehyde, acetone, acetic acid, urea, chloroform, hydrogen chloride, polyethylene glycol, or a combination thereof.

In some embodiments of the present disclosure, the fixing agent is 100% (v/v) methanol, 50% (v/v) ethanol, 95% (v/v) ethanol, 100% (v/v) ethanol, 95% (v/v) denatured ethanol, 80% (v/v) propanol, 80% (v/v) isopropanol, ethanol-diethyl ether fixing agent (volume ratio of ethanol to diethyl ether=1:1), 4% (v/v) formaldehyde fixing agent, acetone fixing agent, 5% (v/v) glacial acetic acid fixing agent, 2 mol/L urea, Carnoy's solution, hydrochloric acid-soluble fixing agent, polyethylene glycol fixing agent, or combinations thereof.

In some embodiments of the present disclosure, the at least one dye includes hematoxylin, Orange G, Eosin Y, light green, Bismarck brown or a combination thereof.

In some embodiments of the present disclosure, the at least one dye includes hematoxylin, Orange G, Eosin Y, light green, and Bismarck brown.

In some embodiments of the present disclosure, the material of the non-epoxy-based microfilm is a transparent polymer material.

In some embodiments of the present disclosure, the transparent polymer material is polyimide, polycarbonate, polyethylene, polyethylene terephthalate, polyethylene naphthoate ester, polymethyl methacrylate, polystyrene, or a combination thereof.

In some embodiments of the present disclosure, the method for preparing a dyeing sample further includes: after step (c), adding a solution for making the biological sample transparent to the non-epoxy-based microfilm, and having the non-epoxy-based microfilm sandwiched between a carrier plate and a cover plate.

In some embodiments of the present disclosure, the cover plate is a cover glass, and the cover plate has a thickness of 0.12 mm to 0.17 mm.

### BRIEF DESCRIPTION OF THE DRAWINGS

The file of this application contains at least one drawing executed in color. Copies of this application with color drawings will be provided by the Office upon request and payment of the necessary fee.

The following will describe embodiments of the present inventive disclosure in detail with reference to the accompanying drawings. It should be noted that, in accordance with standard industry practice, various features are not drawn to scale and are shown for illustrative purposes only. In fact, the dimensions of components may be arbitrarily enlarged or reduced to clearly present the features of the embodiments of the present invention. It should also be noted that the accompanying drawings only illustrate typical embodiments of this disclosure and therefore should not be considered as limiting its scope, as this disclosure can equally apply to other embodiments.

FIG. 1 is a flowchart illustrating a method for preparing a dyeing sample according to some embodiments of the present disclosure.

FIG. 2 to FIG. 4 are diagrams showing the staining results of Comparative Examples 1 to 3 according to some embodiments of the present disclosure.

FIG. 5 to FIG. 6 are diagrams showing the staining results of Example 1 and Example 2 according to some embodiments of the present disclosure.

### DETAILED DESCRIPTION OF THE PREFERRED EMBODIMENTS

The following disclosure provides numerous embodiments or examples for implementing various elements of the provided subject matter. Specific examples of components and their configurations are described below to simplify the description of the embodiments of the present invention. Of course, these are merely examples and are not intended to limit the embodiments of the present inventive disclosure. Furthermore, the embodiments of the present inventive disclosure may repeatedly reference numbers and/or letters in various examples. Such repetition is for the purpose of simplicity and clarity, and does not indicate relationships between different embodiments and/or configurations under discussion.

The following describes some embodiments of the present inventive disclosure, in which additional steps may be provided before, during, and/or after the multiple stages described in these embodiments. Some of the described stages may be replaced or omitted in different embodiments. Although some of the discussed embodiments are executed with steps in a specific order, these steps may still be executed in another logically appropriate order.

The present disclosure provides a method for preparing a dyeing sample, wherein the method can fix an object to be stained in a biological sample that is collected on a non-epoxy-based microfilm on the non-epoxy-based microfilm, and the object to be stained is successfully stained, so that the staining of the cytoplasm and the cell nucleus can be clearly identified under an optical microscope. Since the fixation time in the immobilizing step is much higher than the general fixation time (for example, 15-20 minutes), the object to be stained can be immobilized on the non-epoxy-based microfilm without causing the object to be stained to detach from the non-epoxy-based microfilm during the staining process. Moreover, the dye(s) used in the staining step of the dyeing sample preparation method has/have been filtered to remove dye crystals, thereby preventing dye crystals from contaminating the dyeing sample.

In the present disclosure, the term “about” refers to a numerical range that falls within 25%, 20%, 19%, 18%, 17%, 16%, 15%, 14%, 13%, 12%, 11%, 10%, 9%, 8%, 7%, 6%, 5%, 4%, 3%, 2%, 1%, or less of the stated value in any direction (greater than or less than).

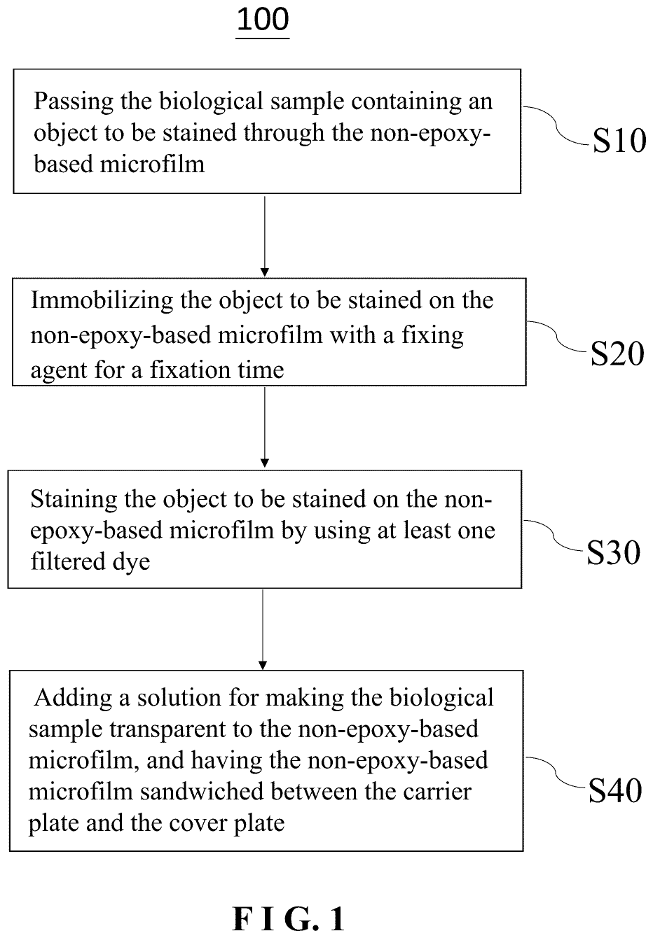

FIG. 1 is a flowchart illustrating a method 100 for preparing a dyeing sample according to some embodiments of the present disclosure. The method 100 for preparing the dyeing sample includes step S10, step S20, and step S30.

Referring to FIG. 1, in one embodiment, step S10 is passing a biological sample containing the object to be stained through a non-epoxy-based microfilm to collect the object to be stained on the non-epoxy-based microfilm.

In some embodiments, examples of the biological sample may include, but are not limited to, whole blood, serum, plasma, pleural fluid, ascites, synovial fluid, cerebrospinal fluid, semen, urine, feces, saliva, nasopharyngeal swab, sputum, throat swab, bronchial aspiration (BA), bronchial alveolar lavage (BL), bronchial brush (BB), amniotic fluid, breast milk, sweat, tears, gastric juice, pus, biopsy, etc. In a specific embodiment, the biological sample may be whole blood. In some embodiments, the object to be stained is cells in the biological sample, particularly tumor cells in the biological sample. Examples of the object to be stained may include, but are not limited to, circulating tumor cells (CTC) in biological samples such as whole blood, serum, plasma, or urine, wherein the size of the object to be stained is larger than the size of micropores on the non-epoxy-based microfilm. In a specific embodiment, the object to be stained is tumor cells in whole blood.

In some embodiments, the non-epoxy-based microfilm is a non-epoxy-based film including multiple micropores, wherein the micropores penetrate through the non-epoxy-based microfilm, and the pore size of the micropores is designed to retain the target on the non-epoxy-based microfilm, for example, micropores with an average diameter less than or equal to 10 μm. In some embodiments, step S10 applies pressure to pass the biological sample containing the object to be stained through the non-epoxy-based microfilm, thereby intercepting the object to be stained with a volume larger than the micropores from the biological sample by the non-epoxy-based microfilm. In a specific embodiment, step S10 uses a microfilter including a non-epoxy-based microfilm (TW Patent No. I769544) proposed by the applicant of the present application to filter the biological sample containing the object to be stained, wherein the biological sample is passed through the non-epoxy-based microfilm by pressure difference, thereby intercepting the object to be stained with a volume larger than the size of micropores from the biological sample by the non-epoxy-based microfilm, and allowing other components with volumes smaller than the micropores in the biological sample to flow out through the micropores.

In some embodiments, examples of materials for the non-epoxy-based microfilm may include transparent polymer materials, wherein the transparent polymer materials may include, polyimide, polycarbonate, polyethylene, polyethylene terephthalate, polyethylene naphthalate, polymethyl methacrylate, polystyrene, or combinations thereof, but are not limited to. In a specific embodiment, the material of the non-epoxy-based microfilm is polyethylene terephthalate. In some embodiments, the shape of micropores on the non-epoxy-based microfilm may be, but is not limited to, rectangular micropores, hexagonal micropores, circular micropores, or micropores of other shapes. In some embodiments, the number of micropores on the non-epoxy-based microfilm may be greater than 50,000. In some embodiments, the distance between two micropores on the non-epoxy-based microfilm is at least 15 μm. In some embodiments, the thickness of the non-epoxy-based microfilm is from 5 μm to 25 μm. In some embodiments, the non-epoxy-based microfilm is formed by laser processing a non-epoxy-based film to form micropores that penetrate through the non-epoxy-based film.

Referring to FIG. 1, in one embodiment, the immobilizing step S20 involves immobilizing the object to be stained on a non-epoxy-based microfilm using a fixing agent at a fixation time. In some embodiments, the components of the fixing agent may include methanol, ethanol, denatured ethanol, propanol, isopropanol, diethyl ether, formaldehyde, acetone, acetic acid, urea, chloroform, hydrochloric acid, polyethylene glycol, or combinations thereof, but are not limited thereto. In some embodiments, the concentration of the aforementioned methanol can be approximately 80% to approximately 100%, for example, it can be 100% (v/v) methanol, but is not limited thereto. In some embodiments, the aforementioned ethanol can be approximately 45% to 100% (v/v) ethanol, for example, 50% (v/v) ethanol, 95% (v/v) ethanol, 100% (v/v) ethanol, but is not limited thereto. In some embodiments, the concentration of the aforementioned denatured ethanol can be approximately 30% to approximately 100%, for example, it can be 95% (v/v) denatured ethanol, but is not limited thereto. In some embodiments, the concentration of the aforementioned propanol can be approximately 60% (v/v) to approximately 100% (v/v), for example, it can be 80% (v/v) propanol, but is not limited thereto. In some embodiments, the concentration of the aforementioned isopropanol can be approximately 60% (v/v) to approximately 100% (v/v), for example, it can be 80% (v/v) isopropanol, but is not limited thereto. In some embodiments, ethanol and diethyl ether can be used in combination, wherein the volume ratio of ethanol to diethyl ether can be approximately 1:1 to approximately 3:1, for example, the volume ratio of ethanol to diethyl ether=1:1, but is not limited thereto. In some embodiments, the concentration of the aforementioned formaldehyde can be approximately 4% (v/v) to approximately 40% (v/v), for example, it can be 4% (v/v) formaldehyde, but is not limited thereto. In some embodiments, the concentration of the aforementioned acetic acid can be approximately 0.5% (v/v) to approximately 10% (v/v), for example, it can be approximately 1% (v/v) acetic acid, wherein the source of acetic acid can be glacial acetic acid, but is not limited thereto. In some embodiments, the concentration of the aforementioned urea can be approximately 1 mol/L to approximately 10 mol/L, for example, it can be 2 mol/L urea, but is not limited thereto. In some embodiments, the fixing agent can be 100% (v/v) methanol, 50% (v/v) ethanol, 95% (v/v) ethanol, 100% (v/v) ethanol, 95% (v/v) denatured ethanol, 80% (v/v) propanol, 80% (v/v) isopropanol, ethanol-diethyl ether fixing agent (volume ratio of ethanol to diethyl ether=1:1), 4% (v/v) formaldehyde fixing agent, acetone fixing agent, 5% (v/v) glacial acetic acid fixing agent, 2 mol/L urea, Carnoy's solution, hydrochloric acid-soluble fixing agent, polyethylene glycol fixing agent, or combinations thereof, but is not limited thereto, wherein all the aforementioned fixing agents expressed in volume percentage (% (v/v)) use water as the solvent. The Carnoy's solution can be composed of ethanol and acetic acid, or can be composed of ethanol, acetic acid, and chloroform. In a specific embodiment, the fixing agent is 95% (v/v) ethanol.

In some embodiments, the fixation time is greater than or equal to 8 hours, preferably 8 hours to 32 hours, for example, it can be 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, 31 hours, or 32 hours, but not limited thereto. If the fixation time is less than 8 hours, the object to be stained may not be stably immobilized on the non-epoxy-based microfilm, resulting in the object to be stained detaching from the non-epoxy-based microfilm. In a specific embodiment, the fixation time is 24 hours. In some embodiments, step S20 involves immersing the non-epoxy-based microfilm that has intercepted the object to be stained in the fixing agent for 8 hours to 32 hours, allowing the object to be stained to be immobilized on the non-epoxy-based microfilm through the dehydrating action of the fixing agent.

Referring to FIG. 1, in one embodiment, step S30 involves staining the object to be stained on the non-epoxy-based microfilm using at least one filtered dye. In some embodiments, the dye may include hematoxylin, Orange G, Eosin Y, light green, Bismarck brown, or combinations thereof, but is not limited thereto. In a specific embodiment, the dye includes hematoxylin, Orange G, Eosin Y, light green, and Bismarck brown. Hematoxylin is used to stain basophilic structures in the object to be stained into blue-purple color, where the basophilic structures can be structures containing nucleic acids in the object to be stained, such as ribosomes and chromosomes in the nucleus. Orange G is used to stain keratin in the object to be stained into orange-yellow color. Eosin Y is used to stain acidophilic structures in the object to be stained into pink color, such as nucleoli in the object to be stained, thus Eosin Y can stain mature superficial cells into pink color. Light green is used to stain cells with high metabolic rates in the object to be stained into green, blue-green, or blue color, where cells with high metabolic rates include intermediate squamous epithelial cells, deep squamous epithelial cells, and columnar cells. Bismarck brown is used to stain components such as acidic mucin. In some embodiments, the filtered dye is obtained by filtering the dye with a filter membrane, thereby removing dye crystals and other impurities that are larger than the pore size of the filter membrane from the dye, but is not limited thereto.

The time for staining the object to be stained using the dye can be adjusted according to needs, for example, it can be 30 seconds to 10 minutes, specifically it can be 30 seconds, 45 seconds, 60 seconds, 1 minute, 2 minutes, 3 minutes, 4 minutes, 5 minutes, 6 minutes, 7 minutes, 8 minutes, 9 minutes, or 10 minutes. In some embodiments, the pore size of the filter membrane is less than or equal to 10.0 μm, for example, 10.0 μm, 5.0 μm, 3.0 μm, 1.0 μm, 0.8 μm, 0.45 μm, 0.22 μm or 0.10 μm, etc., but is not limited thereto. In preferred embodiments, the pore size of the filter membrane is less than or equal to 0.22 μm, thereby more effectively removing dye crystals and impurities from the dye. In a specific embodiment, the pore size of the filter membrane is 0.22 μm. In some embodiments, step S30 involves immersing the non-epoxy-based microfilm in at least one dye, and using washing solution or destaining solution to remove excess dye, thereby staining the object to be stained on the non-epoxy-based microfilm to obtain the dyeing sample. The washing solution can be filtered water, distilled water, double-distilled water, deionized water, reverse osmosis water (abbreviated as: RO water), pure water, ultra-pure water, etc., but is not limited thereto. The washing solution can also be the fixing agent as mentioned above, such as 95% (v/v) ethanol, etc., thus providing the effect of immobilizing the object to be stained while washing. The destaining solution can be ethanol containing hydrochloric acid and acetic acid, for example, 70% (v/v) ethanol containing 0.5% (v/v) hydrochloric acid, wherein the aforementioned destaining solution expressed in volume percentage concentration (% (v/v)) uses water as the solvent. In a specific embodiment, the destaining solution is 70% (v/v) ethanol containing 0.5% (v/v) hydrochloric acid. The time for destaining solution to remove excess dye using washing solution can be adjusted according to needs, for example, it can be 1 second to 30 minutes, specifically it can be 1 second, 5 seconds, 10 seconds, 15 seconds, 30 seconds, 45 seconds, 1 minute, 2 minutes, 3 minutes, 4 minutes, 5 minutes, 6 minutes, 7 minutes, 8 minutes, 9 minutes, 10 minutes, 15 minutes, 20 minutes, or 25 minutes, etc.

Referring to FIG. 1, in some embodiments, the preparation method 100 of the dyeing sample further includes step S40. Step S40 is performed after step S30, which involves adding a solution for making the biological sample transparent to the non-epoxy-based microfilm, and having the non-epoxy-based microfilm sandwiched between a carrier plate and a cover plate. In some embodiments, the solution for making the biological sample transparent can be a clearing agent, specifically it can be xylene, isopropanol, limonene, other xylene-free clearing agents, or combinations thereof, wherein the other xylene-free clearing agents include, for example, Tissue Clearing/Staining Kit (CytoVista™), and Tissue Clearing Kits (Abcam), etc., but is not limited thereto. In a specific embodiment, the solution for making the biological sample transparent is xylene. In some embodiments, the time for making the biological sample transparent using clearing agent can be 1 minute to 30 minutes, specifically it can be 1 minute, 2 minutes, 3 minutes, 4 minutes, 5 minutes, 6 minutes, 7 minutes, 8 minutes, 9 minutes, 10 minutes, 15 minutes, 20 minutes, 25 minutes, or 30 minutes, but is not limited thereto. In some embodiments, the carrier plate is a transparent carrier plate, such as a slide glass, etc., but is not limited thereto. In some embodiments, the cover plate is a transparent cover plate, but is not limited thereto, such as a cover glass, etc. In a specific embodiment, the carrier plate is a slide glass, and the cover plate is a cover glass. The thickness of the cover plate can be any thickness, preferably 0.12 mm to 0.17 mm, for example, 0.13 mm, 0.14 mm, 0.15 mm, 0.16 mm, etc., but is not limited thereto. Through having a cover glass thickness greater than 0.12 mm, the cover glass has a certain weight, therefore when the cover glass is placed on the slide glass, it can reduce the gap width between the cover glass and slide glass, thereby reducing the rate at which the solution for making the biological sample transparent flows out from the gap between the cover glass and slide glass, to extend the preservation time of the dyeing sample. In some embodiments, a mounting medium can be used to seal the gap between the cover glass and slide glass, thereby further reducing the rate at which the solution for making the biological sample transparent flows out. In some embodiments, step S40 involves adding the solution for making the biological sample transparent onto the non-epoxy-based microfilm to make the dyeing sample transparent, then having the non-epoxy-based microfilm sandwiched between the carrier plate and cover plate to preserve the dyeing sample.

### EXAMPLES

### [Cell Staining Experiment]

The following provides examples and comparative examples. In Comparative examples 1-3 and Examples 1-2, the microfilter containing non-epoxy-based microfilm previously proposed by the applicant of this application (TW Patent No. I769544) was used to filter biological samples containing objects to be stained. Through pressure difference, the biological sample containing objects to be stained passes through the non-epoxy-based microfilm, allowing objects to be stained in the biological sample with volumes larger than the micropore size to be intercepted by the non-epoxy-based microfilm. 7.5 mL of whole blood serves as a demonstration example of the biological sample, with additional breast cancer cells (cell line: Michigan Cancer Foundation-7; MCF-7) added as the dyeing sample therein. Breast cancer cells generally have larger volumes, making them easily intercepted by the non-epoxy-based microfilm. Additionally, polyethylene terephthalate is used as a demonstration example for the material of the non-epoxy-based microfilm.

### Comparative Examples 1-3

### 1. Comparative Example 1

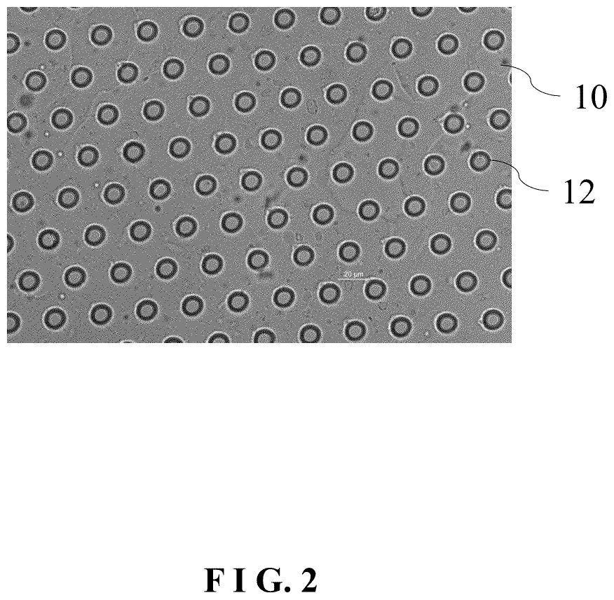

In Comparative Example 1, Papanicolaou staining reagent (Product name: Papanicolaou (PAP) Red Stain Kit (Cytology Stain); Product number: ab150679) is used to stain the objects to be stained on the non-epoxy-based microfilm, where the staining method is performed according to the staining method provided by the aforementioned Papanicolaou staining reagent. Specifically, the non-epoxy-based microfilm is first immersed sequentially in 95% (v/v) ethanol and 70% (v/v) ethanol for 5 minutes for immobilizing, followed by the non-epoxy-based microfilm being immersed in RO water for 2 minutes. Then, the non-epoxy-based microfilm is immersed in hematoxylin for 5.5 minutes, followed by the excess dye being washed away with RO water. Subsequently, the non-epoxy-based microfilm is immersed in 95% (v/v) ethanol for immobilizing. Then, the non-epoxy-based microfilm is immersed in Orange G-6 for 2.5 minutes. Afterward, the excess dye is washed away with 100% (v/v) ethanol. Then, the non-epoxy-based microfilm is immersed in EA-50 staining solution containing Eosin Y, light green, and Bismarck brown for 3.5 minutes. Subsequently, the excess dye is washed away with 100% (v/v) ethanol, followed by three rinses with 100% (v/v) ethanol. Finally, the non-epoxy-based microfilm is immersed in xylene for making the biological sample transparent, and observations are made using an optical microscope at 40× magnification. The staining results of Comparative Example 1 are shown in FIG. 2, where a scale bar of 20 μm is displayed.

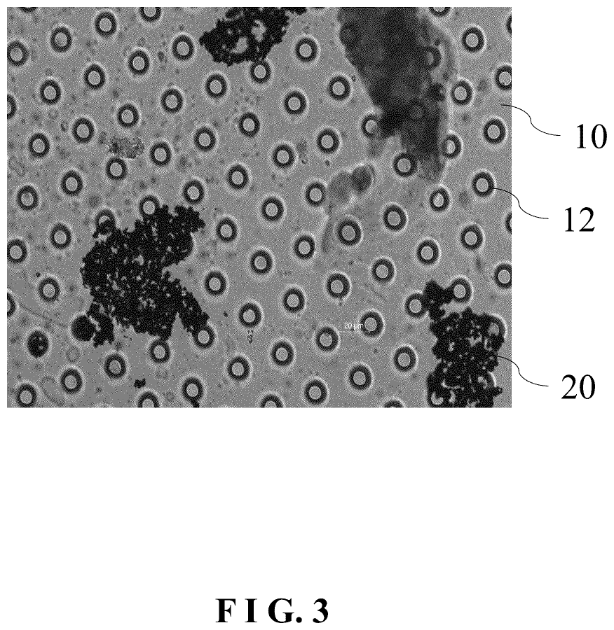

Referring to FIG. 2, since in Comparative Example 1, the objects to be stained are immobilized on the non-epoxy-based microfilm 10 using 95% (v/v) ethanol for only 5 minutes at the beginning, after the preparation of Comparative Example 1 is completed, only the non-epoxy-based microfilm 10 and its micropores 12 are observed, while no cells are observed due to the breast cancer cells not being immobilized on the non-epoxy-based microfilm 10. Additionally, although dye crystals (such as the dye crystals 20 shown in FIG. 3) are not observed in FIG. 2 since it is only a photograph of a partial field of view, in Comparative Example 1, a large amount of dye crystals actually exists outside the partial field of view shown in FIG. 2 due to the dye not being filtered in advance, resulting in serious interference with cell observation.

### 2. Comparative Example 2

In Comparative Example 2, Papanicolaou staining reagent (Product name: Papanicolaou (PAP) Red Stain Kit (Cytology Stain); Product number: ab150679) is used to stain the objects to be stained on the non-epoxy-based microfilm, where the staining method is performed according to the staining method provided by the aforementioned Papanicolaou staining reagent. Specifically, the non-epoxy-based microfilm is first immersed in 95% (v/v) ethanol for 15 minutes, then immersed in 70% (v/v) ethanol for 5 minutes for immobilizing, followed by the non-epoxy-based microfilm being immersed in RO water for 2 minutes. Then, the non-epoxy-based microfilm is immersed in hematoxylin for 5.5 minutes, followed by the excess dye being washed away with RO water. Subsequently, the non-epoxy-based microfilm is immersed in 95% (v/v) ethanol for immobilizing. Then, the non-epoxy-based microfilm is immersed in Orange G-6 for 2.5 minutes. Afterward, the excess dye is washed away with 100% (v/v) ethanol. Then, the non-epoxy-based microfilm is immersed in EA-50 staining solution containing Eosin Y, light green, and Bismarck brown for 3.5 minutes. Subsequently, the excess dye is washed away with 100% (v/v) ethanol, followed by three rinses with 100% (v/v) ethanol. Finally, the non-epoxy-based microfilm is immersed in xylene for making the biological sample transparent, and observations are made using an optical microscope at 40× magnification. The preparation method of Comparative Example 2 is basically consistent with that of Comparative Example 1, with the only difference being that the time for immersing the non-epoxy-based microfilm in 95% (v/v) ethanol at the beginning is changed from 5 minutes to 15 minutes. The staining results of Comparative Example 2 are shown in FIG. 3, where a scale bar of 20 μm is displayed.

Referring to FIG. 3, although in Comparative Example 2 the time for immobilizing the objects to be stained on the non-epoxy-based microfilm 10 using 95% (v/v) ethanol at the beginning is extended to 15 minutes, the staining results remain poor. In the field of view, in addition to the non-epoxy-based microfilm 10 and its micropores 12, obvious contamination of dye crystals 20 is observed since the dye is not filtered in advance in Comparative Example 2, resulting in serious interference with cell observation. Furthermore, since the fixation time is only extended to 15 minutes, this may lead to the cells not being firmly immobilized on the non-epoxy-based microfilm 10, thereby affecting the staining effect, and since the staining of cytoplasm and nucleus cannot be clearly observed simultaneously, it is impossible to identify whether the stained objects are cells or impurities, resulting in serious interference with cell observation.

### 3. Comparative Example 3

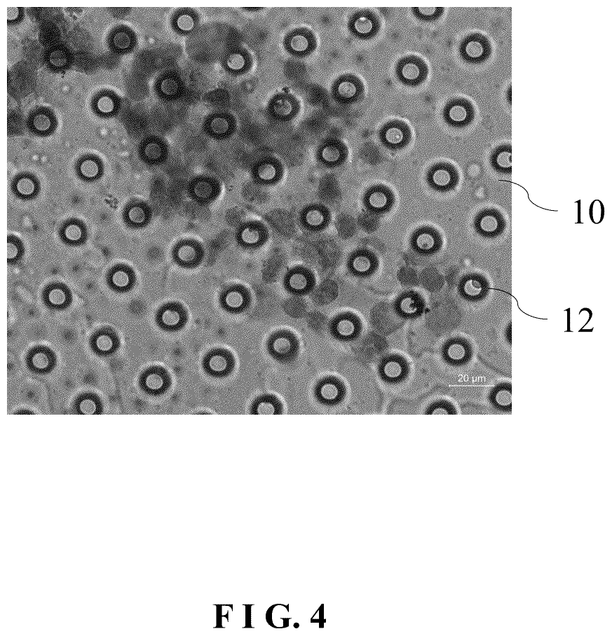

In Comparative Example 3, Papanicolaou staining reagent (Product name: Papanicolaou (PAP) Red Stain Kit (Cytology Stain); Product number: ab150679) is used to stain the objects to be stained on the non-epoxy-based microfilm, where the staining method is performed according to the staining method provided by the aforementioned Papanicolaou staining reagent. Specifically, the non-epoxy-based microfilm is first immersed in 95% (v/v) ethanol for 15 minutes, then immersed in 70% (v/v) ethanol for 5 minutes for immobilizing, followed by the non-epoxy-based microfilm being immersed in RO water for 2 minutes. Then, the non-epoxy-based microfilm is immersed in hematoxylin for 5.5 minutes, followed by the excess dye being washed away with RO water. Subsequently, the non-epoxy-based microfilm is immersed in 95% (v/v) ethanol for immobilizing. Then, the non-epoxy-based microfilm is immersed in Orange G-6 for 2.5 minutes. Afterward, the excess dye is washed away with 100% (v/v) ethanol. Then, the non-epoxy-based microfilm is immersed in EA-50 staining solution containing Eosin Y, light green, and Bismarck brown for 3.5 minutes. Subsequently, the excess dye is washed away with 100% (v/v) ethanol, followed by three rinses with 100% (v/v) ethanol. Finally, the non-epoxy-based microfilm is immersed in xylene for making the biological sample transparent, and observations are made using an optical microscope at 40× magnification. The preparation method of Comparative Example 3 is basically consistent with that of Comparative Example 1, with the differences being that the time for immersing the non-epoxy-based microfilm in 95% (v/v) ethanol at the beginning is changed from 5 minutes to 15 minutes, and before the staining step is performed, hematoxylin, Orange G-6, and EA-50 staining solution are filtered through a filter membrane with a pore size of 0.22 μm. The staining results of Comparative Example 3 are shown in FIG. 4, where a scale bar of 20 μm is displayed.

Referring to FIG. 4, although in Comparative Example 3 the time for immobilizing the objects to be stained on the non-epoxy-based microfilm 10 using 95% (v/v) ethanol at the beginning is extended to 15 minutes, the staining results remain poor. Although contamination of dye crystals 20 as shown in FIG. 3 is not observed in the field of view not observed in the field of view in Comparative Example 3 due to prior filtration of the dye, since the fixation time in Comparative Example 3 is only extended to 15 minutes, this may result in cells not being firmly immobilized on the non-epoxy-based microfilm 10, thereby affecting the staining effect, Furthermore, because both cytoplasmic staining and nuclear staining are not able to be clearly observed simultaneously, it is impossible to identify whether the stained objects are cells or impurities, severely affecting cell observation.

### Examples 1-2

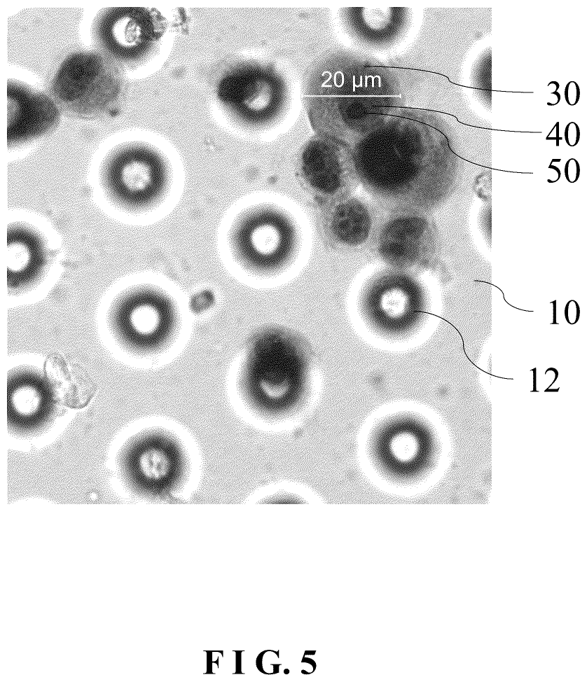

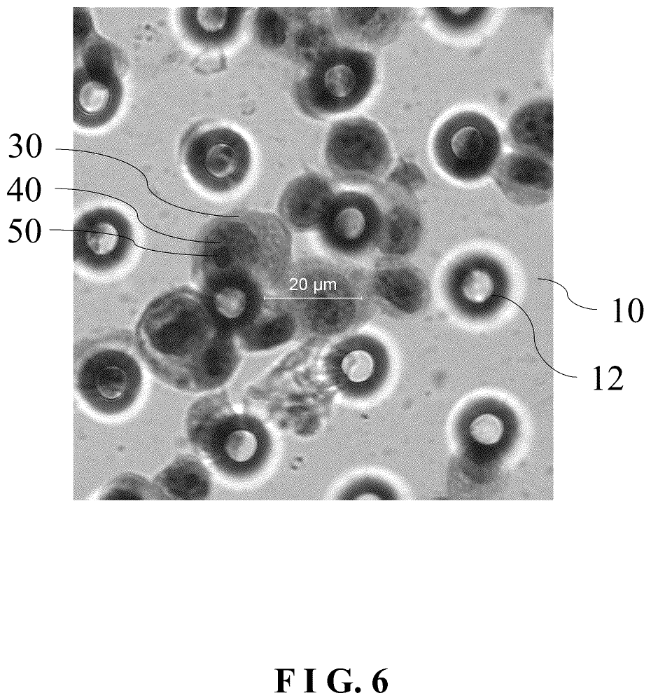

Examples 1-2 independently perform the preparation of stained samples using the preparation method 100 of stained samples disclosed herein, and both follow the same step sequence. Specifically, after the objects to be stained are intercepted by the non-epoxy-based microfilm, the non-epoxy-based microfilm is immersed in 95% (v/v) ethanol for 24 hours. Then, the non-epoxy-based microfilm is immersed in RO water for 2 minutes to remove residual ethanol. Subsequently, the non-epoxy-based microfilm is immersed in hematoxylin (Product name: Gill's Hematoxylin V) for 5.5 minutes. Then, the non-epoxy-based microfilm is immersed in RO water for 3 minutes. Next, the non-epoxy-based microfilm is immersed in destaining solution for 15 seconds to remove excess dye, where the destaining solution is 70% (v/v) ethanol containing 0.5% (v/v) hydrochloric acid. Subsequently, the non-epoxy-based microfilm is immersed sequentially in RO water and 95% (v/v) ethanol for 2 minutes to remove the destaining solution. Then, the non-epoxy-based microfilm is immersed in Orange G (Product name: orange G-6) for 2.5 minutes. Afterward, the non-epoxy-based microfilm is immersed in 95% (v/v) ethanol for 2 minutes to remove excess dye. Subsequently, the non-epoxy-based microfilm is immersed in EA-50 staining solution containing Eosin Y, light green, and Bismarck brown for 3.5 minutes. Then, the non-epoxy-based microfilm is immersed in 95% (v/v) ethanol for 4 minutes to remove excess dye. Next, the non-epoxy-based microfilm is immersed in 100% (v/v) ethanol for 7.5 minutes for cell dehydration and immobilization. Subsequently, the non-epoxy-based microfilm is immersed in xylene for 20 minutes for making the biological sample transparent, followed by observations using an optical microscope at 40× magnification. The hematoxylin, Orange G, and EA-50 staining solution containing Eosin Y, light green, and Bismarck brown used in Examples 1-2 are all filtered through a filter membrane with a pore size of 0.22 μm before being used to stain the objects to be stained, to filter out dye crystals and impurities in the dye. The staining results of Example 1 are shown in FIG. 5. The staining results of Example 2 are shown in FIG. 6, where scale bars of 20 μm are displayed in both FIG. 5 and FIG. 6.

Referring to FIG. 5 and FIG. 6, in Examples 1 and 2, the time for immobilizing the objects to be stained on the non-epoxy-based microfilm 10 using 95% (v/v) ethanol at the beginning is significantly extended to 24 hours, and the dye is filtered through a filter membrane before use, therefore the cytoplasm 30, nucleus 40, and nucleolus 50 of the cells can be clearly observed in the field of view, enabling clear identification of cell morphology, which allows examiners to effectively distinguish tumor cells based on their morphological features.

Based on the above, it is shown that in Comparative Examples 1-3, under conventional fixation time, the objects to be stained cannot be firmly immobilized on the non-epoxy-based microfilm due to insufficient fixation time. Additionally, Comparative Example 2 shows that if the dye is not filtered before the objects to be stained are stained, dye crystal contamination may occur in the dyeing sample, thereby affecting the quality of the dyeing sample. In contrast, in Examples 1-2 prepared according to the preparation method 100 of the dyeing sample of the present application, numerous cells can be observed in the dyeing sample due to sufficient fixation time. Furthermore, in Examples 1-2 prepared according to the preparation method 100 of the dyeing sample of the present application, since the dye is filtered before the objects to be stained are stained, thereby removing dye crystals and other impurities in the dye, the cytoplasm and nucleus of the cells can be clearly observed in the dyeing sample, and even the nucleolus in the nucleus can be clearly observed.

### [Cell Counting Experiment]

In this experiment, cell counting is performed through optical microscope on the dyeing samples prepared according to the preparation method of Comparative Example 1 and the dyeing samples prepared according to the preparation methods of Examples 1-2, where only cells with clearly observable cytoplasm staining and nucleus are counted as objects for cell counting. The results of the cell counting experiment show that no objects that can be clearly identified as cells are observed in the dyeing samples prepared according to the preparation method of Comparative Example 1, while 2,439 cells are observed in the dyeing samples prepared according to the preparation methods of Examples 1-2.

Based on the above, it is further confirmed by the cell counting experiment that under conventional fixation time, due to insufficient fixation time, no objects that can be identified as cells are found on the non-epoxy-based microfilm. In contrast, in the dyeing samples prepared using the preparation method of the dyeing sample of the present application, thousands of successfully stained cells are successfully observed due to sufficient fixation time and pre-filtering of the dye.

In summary, from the above experimental results, it is known that through significantly extending the time for immobilizing the objects to be stained and pre-filtering the dye, the preparation method of the dyeing sample of the present application enables the objects to be stained to be firmly immobilized on the non-epoxy-based microfilm, and through pre-filtering the dye, interference from dye crystals and impurities in the dye during observation is avoided, thereby solving the problems of conventional chemical staining techniques where the objects to be stained cannot be effectively immobilized on the non-epoxy-based microfilm and circulating tumor cells on the non-epoxy-based microfilm are difficult to be successfully stained.

The above outlines components of several embodiments to facilitate understanding of the embodiments of the present invention from the perspective of those having ordinary skill in the pertinent art. Those having ordinary skill in the pertinent art should understand that they can design or modify other processes and structures based on the embodiments of the present invention to achieve the same purposes and/or advantages as the embodiments introduced herein. Those having ordinary skill in the pertinent art should also understand that such equivalent processes and structures do not depart from the spirit and scope of the present invention, and that they can make various changes, substitutions, and alterations without departing from the spirit and scope of the present invention.

What is claimed is:

1. A method for preparing a dyeing sample, comprising:
(a) passing a biological sample containing an object to be stained through a non-epoxy-based microfilm to collect the object to be stained on the non-epoxy-based microfilm;
(b) immobilizing the object to be stained on the non-epoxy-based microfilm with a fixing agent at a fixation time, wherein the fixation time is greater than or equal to 8 hours; and
(c) staining the object to be stained on the non-epoxy-based microfilm by using at least one filtered dye.

2. The method for preparing a dyeing sample as claimed in claim 1, wherein the fixation time is 8 hours to 32 hours.

3. The method for preparing a dyeing sample as claimed in claim 1, wherein the at least one filtered dye is obtained by filtering at least one dye through a filter membrane.

4. The method for preparing a dyeing sample as claimed in claim 3, wherein a pore size of the filter membrane is less than or equal to 0.22 μm.

5. The method for preparing a dyeing sample as claimed in claim 1, wherein the fixing agent comprises methanol, ethanol, denatured ethanol, propanol, isopropanol, diethyl ether, formaldehyde, acetone, acetic acid, urea, chloroform, hydrochloric acid, polyethylene glycol, or combinations thereof.

6. The method for preparing a dyeing sample as claimed in claim 5, wherein the fixing agent is 100% (v/v) methanol, 50% (v/v) ethanol, 95% (v/v) ethanol, 100% (v/v) ethanol, 95% (v/v) denatured ethanol, 80% (v/v) propanol, 80% (v/v) isopropanol, ethanol-diethyl ether fixing agent (volume ratio of ethanol to diethyl ether=1:1), 4% (v/v) formaldehyde fixing agent, acetone fixing agent, 5% (v/v) glacial acetic acid fixing agent, 2 mol/L urea, Carnoy's solution, hydrochloric acid-soluble fixing agent, polyethylene glycol fixing agent, or combinations thereof.

7. The method for preparing a dyeing sample as claimed in claim 3, wherein the at least one dye comprises hematoxylin, Orange G, Eosin Y, light green, Bismarck brown, or a combination thereof.

8. The method for preparing a dyeing sample as claimed in claim 7, wherein the at least one dye comprises hematoxylin, Orange G, Eosin Y, light green, and Bismarck brown.

9. The method for preparing a dyeing sample as claimed in claim 1, wherein the material of the non-epoxy-based microfilm is a transparent polymer material.

10. The method for preparing a dyeing sample as claimed in claim 9, wherein the transparent polymer material is polyimide, polycarbonate, polyethylene, polyethylene terephthalate, polyethylene naphthoate ester, polymethyl methacrylate, polystyrene, or a combination thereof.

11. The method for preparing a dyeing sample as claimed in claim 1, further comprising: after step (c), adding a solution for making the biological sample transparent to the non-epoxy-based microfilm, and having the non-epoxy-based microfilm sandwiched between a carrier plate and a cover plate.

12. The method for preparing a dyeing sample as claimed in claim 11, wherein the cover plate is a cover glass, and the cover plate has a thickness of 0.12 mm to 0.17 mm.
